(19) United States
(12) Patent Application Publication
(10) Pub. No.: US 2019/0273440 A1
(43) Pub. Date: Sep. 5, 2019

(54) Power Converter

(71) Applicant: Hitachi Automotive Systems, Ltd., Hitachinaka-shi, Ibaraki (JP)

(72) Inventors: Daisuke IKARASHI, Tokyo (JP); Takuya ISHIGAKI, Tokyo (JP); Tatsuro NAMBU, Hitachinaka-shi (JP); Michihiro ASANUMA, Hitachinaka-shi (JP)

(21) Appl. No.: 16/319,857

(22) PCT Filed: May 11, 2017
(86) PCT No.: PCT/JP2017/017860

§ 371 Date: Jan. 23, 2019

(30) Foreign Application Priority Data
Aug. 9, 2016 (JP) 2016-156624

(51) Int. Cl. H02M 3/335; H02M 1/08; H02N 2/18; F16F 9/53; F16F 1/36

(52) U.S. Cl. CPC H02M 3/33523; H02M 1/08; H02N 2/181; H02M 2001/0025; F16F 1/3605; F16F 1/3615; F16F 9/532

(57) ABSTRACT

Provided is a power converter for converting a DC input voltage to a DC output voltage and outputting the DC output voltage to a load, including: a discharge resistor which discharges electric charges accumulated in the load, a discharge switch which switches an electric conduction state of the discharge resistor; and a discharge controller which controls the discharge switch so that the output voltage becomes a predetermined target voltage, wherein the discharge controller controls the discharge switch to cut off electric conduction of the discharge resistor when the output voltage is lower than a predetermined threshold voltage that is higher than the target voltage, and wherein the discharge controller corrects the threshold voltage in response to a temperature change of the load.

### TECHNICAL FIELD

The present invention relates to a power converter.

### BACKGROUND ART

An electro-rheological fluid (ERF) is a fluid that can change a viscosity of the fluid by applying an electric field from the outside. Since the ERF can directly control the viscosity of the fluid with an electric signal without having a moving unit, the ERF has an advantage of high responsiveness. Application examples of the ERF in vehicles include ERF dampers, ERF clutches, ERF engine mounts, and the like that are used for impact absorption, torque control, vibration control, and the like, respectively. PTL 1 discloses a method of reducing power loss without decreasing responsiveness of a power converter by providing a discharge switch for discharging electric charges stored in an ERF in the power converter that applies a high voltage to a shock absorber using the ERF.

### CITATION LIST

### Patent Literature

PTL 1: JP-A-8-91031

### SUMMARY OF INVENTION

### Technical Problem

In the technique disclosed in PTL 1, a turn-off time of a discharge switch is determined in response to a charge time constant of a voltage dividing condenser connected in parallel with the discharge switch. There is a problem that the responsiveness of the power converter is decreased, which is caused by a dead time due to the turn-off time.

### Solution to Problem

According to a first aspect of the present invention, provided is a power converter for converting a DC input voltage to a DC output voltage and outputting the DC output voltage to a load, the power converter including: a discharge resistor for discharging electric charges accumulated in the load, a discharge switch for switching an electric conduction state of the discharge resistor; and a discharge controller for controlling the discharge switch so that the output voltage becomes a predetermined target voltage, wherein the discharge controller controls the discharge switch to cut off electric conduction of the discharge resistor when the output voltage is lower than a predetermined threshold voltage that is higher than the target voltage, and the discharge controller corrects the threshold voltage in response to a temperature change of the load.

According to a second aspect of the present invention, provided is a power converter for converting a DC input voltage to a DC output voltage and outputting the DC output voltage to a load, the power converter including: a discharge resistor for discharging electric charges accumulated in the load, a discharge switch for switching an electric conduction state of the discharge resistor, and a discharge controller for controlling the discharge switch so that the output voltage becomes a predetermined target voltage, wherein the discharge controller controls the discharge switch to cut off the electric conduction of the discharge resistor when the output voltage is lower than a predetermined threshold voltage that is higher than the target voltage, and the discharge controller corrects the threshold voltage in response to a change in a product of an electrostatic capacitance value and a resistance value of the load.

### Advantageous Effects of Invention

According to the present invention, it is possible to improve responsiveness of a power converter.

### BRIEF DESCRIPTION OF DRAWINGS

FIG. 1 is a diagram illustrating a basic configuration of a power converter according to a first embodiment of the present invention.

FIG. 2 is a diagram illustrating a configuration example of a discharge switch in a power converter.

FIG. 3 is a diagram for explaining a problem of the related art.

FIG. 4 is a diagram for explaining a principle of a method of controlling a discharge switch by the power converter of this embodiment.

FIG. 5 is a diagram for explaining a principle of a method of correcting a threshold voltage by the power converter according to this embodiment.

FIG. 6 is a diagram illustrating characteristics of a hysteresis comparator in a discharge controller.

FIG. 7 is a diagram illustrating a control flow of a discharge switch according to the first embodiment of the present invention.

FIG. 8 is a diagram illustrating a state of a voltage change of a load and a discharge resistor when a load temperature is a room temperature.

FIG. 9 is a diagram illustrating a state of the voltage change of the load and the discharge resistor when the load temperature is a high temperature.

FIG. 10 is a diagram illustrating a state of the voltage change of the load and the discharge resistor when the load temperature is a low temperature.

FIG. 11 is a diagram illustrating a control flow of a discharge switch according to a second embodiment of the present invention.

FIG. 12 is a diagram illustrating a configuration of a power converter according to a third embodiment of the present invention.

### DESCRIPTION OF EMBODIMENTS

Hereinafter, embodiments of the present invention will be described with reference to the drawings. In addition, the following embodiments exhibit one mode of the present invention, and the present invention includes other modes as long as the modes do not depart from the spirit of the invention.

### First Embodiment

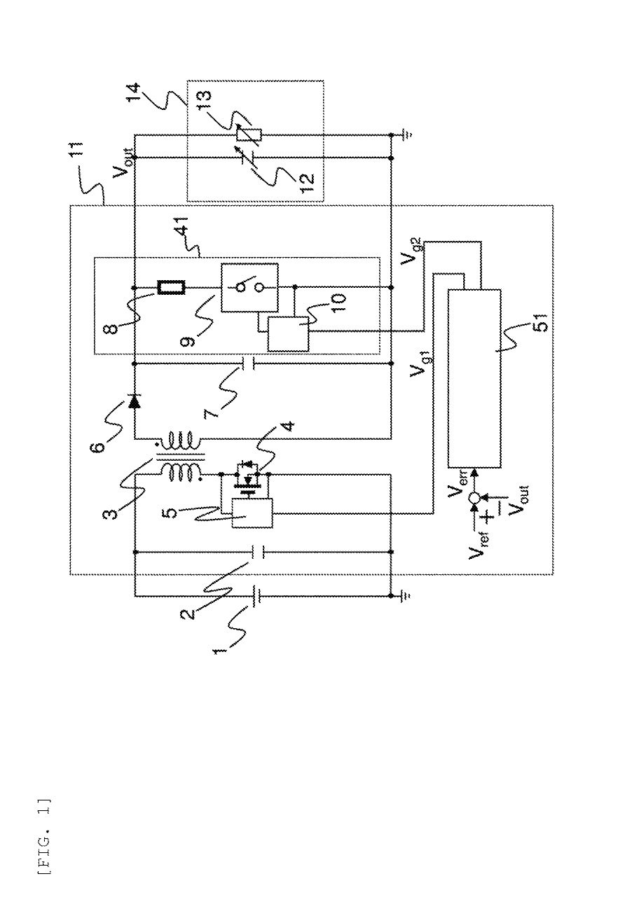

First, a first embodiment of the present invention will be described. In the first embodiment, an embodiment of the present invention will be described with reference to FIGS. 1 to 10.

FIG. 1 is a diagram illustrating a basic configuration of a power converter 11 according to the first embodiment of the present invention. The power converter 11 illustrated in FIG. 1 converts a DC voltage input from a DC power supply 1 to a high DC voltage and outputs the DC voltage to a load 14. The power converter 11 includes an input-side smoothing condenser 2, a step-up transformer 3, an AC switching element 4, an AC switching element driving circuit 5, a rectifier diode 6, an output-side smoothing condenser 7, a discharge resistor 8, a discharge switch 9, a discharge switch driving circuit 10 and a discharge controller 51. The load 14 is a matter to which a high DC voltage is applied by the power converter 11 and includes a capacitive component 12 and a resistive component 13. The load 14 is, for example, an ERF or a dielectric elastomer.

A difference value Vₑᵣᵣ that is obtained by subtracting an output voltage Vₒᵤₜ of the power converter 11 from a predetermined target voltage V_{ref} is input to the discharge controller 51. Based on the difference value Vₑᵣᵣ, the discharge controller 51 outputs a control signal V_{g1} to the AC switching element driving circuit 5 and a control signal V_{g2} to the discharge switch driving circuit 10. The AC switching element driving circuit 5 drives the AC switching element 4 in response to the control signal V_{g1}. The discharge switch driving circuit 10 drives the discharge switch 9 in response to the control signal V_{g2}.

Based on the difference value Vₑᵣᵣ, the discharge controller 51 switches the outputs of the control signals V_{g1} and V_{g2} so that the power converter 11 performs a voltage step-up operation or a discharge operation. During the voltage step-up operation, the discharge controller 51 outputs the control signal V_{g1} so that the AC switching element 4 repeats the on state and the off state at a high speed, and outputs the control signal V_{g2} so that the discharge switch 9 is turned off. At this time, an input voltage from the DC power supply 1 is converted to a high frequency AC voltage (rectangular wave voltage) by on/off operation of the AC switching element 4. After the AC voltage is stepped up by the step-up transformer 3, the AC voltage is converted to a DC voltage by the rectifier diode 6. As a result, a high output voltage Vₒᵤₜ is output from the power converter 11 to the load 14.

On the other hand, during the discharge operation of the power converter 11, the discharge controller 51 outputs the control signal V_{g1} so that the AC switching element 4 is turned off, and outputs the control signal V_{g2} so that the discharge switch 9 is turned on. At this time, since a high-frequency AC voltage is not applied to the step-up transformer 3, the voltage step-up operation is stopped in the power converter 11. In addition, the discharge resistor 8 is in an electric conduction state, and electric charges accumulated in the capacitive component 12 of the load 14 and the output-side smoothing condenser 7 are discharged by the discharge resistor 8. Preferably, the resistance value of the discharge resistor 8 is smaller than the resistance value of the resistive component 13 of the load 14 so that the discharge in the discharge resistor 8 is efficiently performed.

According to the above-described operation, the discharge controller 51 can control the AC switching element 4 and the discharge switch 9 so that the output voltage Vₒᵤₜ becomes equal to the target voltage V_{ref}, based on the difference Vₑᵣᵣ between the target voltage V_{ref} and the output voltage Vₒᵤₜ.

Next, the discharge switch 9 will be described. The discharge switch 9 maybe configured with one high-withstand-voltage switch. However, in this configuration, since the high-voltage switch is expensive, the cost of the discharge switch 9 is increased. Therefore, as described below, preferably the discharge switch 9 is configured with a plurality of low-withstand-voltage or medium-withstand-voltage semiconductor switching elements.

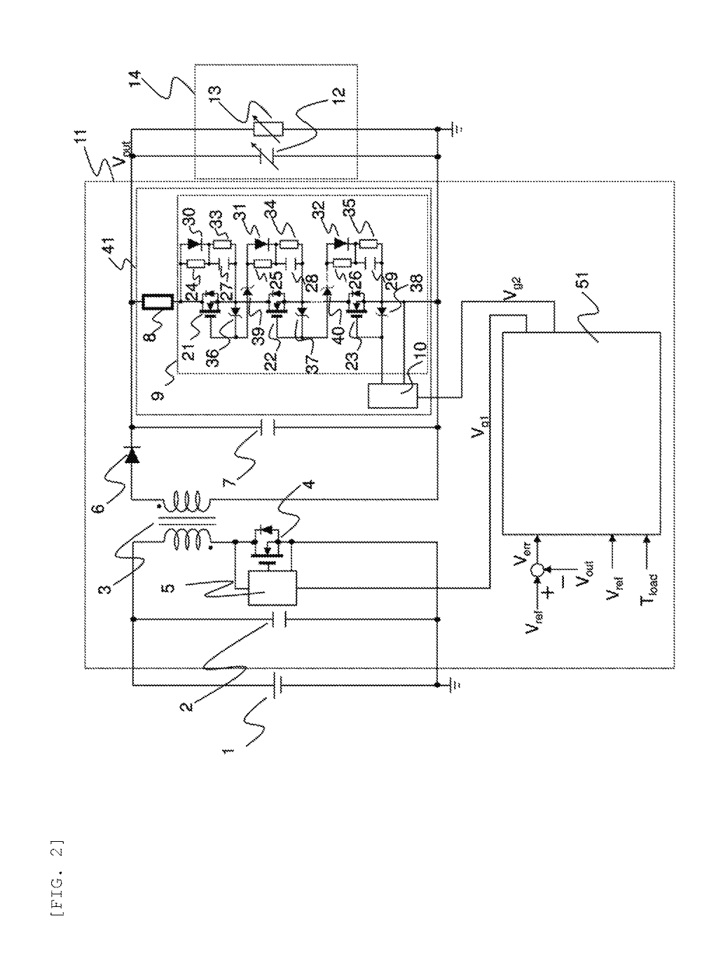

FIG. 2 is a diagram illustrating a configuration example of the discharge switch 9 in the power converter 11. In the example of FIG. 2, the discharge switch 9 is configured to connect the low-withstand-voltage or medium-withstand-voltage semiconductor switching elements 21 to 23 in series. In this manner, by configuring the discharge switch 9 by using the relatively inexpensive low-withstand-voltage or medium-withstand-voltage semiconductor switching elements 21 to 23, a high-withstand-voltage switch is unnecessary to be used, and thus, it is possible to reduce the cost of the discharge switch 9.

In FIG. 2, n-type MOSFETs are used for the semiconductor switches 21 to 23, respectively. In the semiconductor switches 21 to 23, gate charging circuits of snubber circuit/MOSFETs for preventing a transient voltage imbalance at on/off time between the semiconductor switches are connected between the drain terminals and the source terminals. The gate charging circuit of the snubber circuit MOSFET is configured with gate charge resistors 24 to 26, voltage dividing condensers 27 to 29, charging diodes 30 to 32, and voltage dividing resistors 33 to 35, respectively. In addition, Zener diodes 36 to 38 are connected between the gate terminals and the source terminals of the respective semiconductor switches 21 to 23, and the gate charging circuits of the snubber circuit MOSFETs of the semiconductor switches 22 and 23 are connected to the gate terminals of the respective semiconductor switches 21 and 22 through Zener diodes 39 and 40. As a result, necessary discharge voltages are output from the discharge switch driving circuit 10 to the gate terminals of the semiconductor switches 21 to 23, respectively.

As described above, when the discharge switch 9 is configured by directly connecting the plurality of semiconductor switching elements 21 to 23 in series, it is necessary to connect the voltage dividing condensers 27 to 29 in parallel with each semiconductor switching element. However, when the voltage dividing condensers 27 to 29 are connected in this manner, even if all of the semiconductor switching elements 21 to 23 are turned off, the charging of the voltage dividing condensers 27 to 29 is continued, and thus, the current continues to flow to the discharge switch 9 until the total voltage of the voltage dividing condensers 27 to 29 becomes equal to the output voltage Vₒᵤₜ of the power converter 11. Therefore, the turning off of the discharge switch 9 is not completed. As a result, after the semiconductor switching elements 21 to 23 in the discharge switch 9 are turned off, an additional turn-off time occurs, and thus, a high voltage continues to be applied to the discharge resistor 8. For the turn-off time, the output side of the power converter 11 is in a low impedance state, and if the power converter 11 performs the voltage step-up operation, there is a concern that an overcurrent is generated, and thus, the operation cannot be shifted to the next voltage step-up operation. As described above, in the related art, the turn-off time of the discharge switch 9 generated by the voltage dividing condensers 27 to 29 becomes a dead time when the operation cannot be shifted to the next voltage step-up operation, which is a factor of lowering the responsiveness of the power converter 11.

In addition, the turn-off time of the discharge switch 9 is determined in response to the charge time constant of the voltage dividing condensers 27 to 29. The charge time constant of the voltage dividing condensers 27 to 29 is a value determined by electrostatic capacitance values of the capacitive components 12 of the voltage dividing condensers 27 to 29, the output-side smoothing condenser 7, and the load 14, resistance values of the discharge resistor 8, the gate charge resistors 24 to 26, and the resistive component 13 of the load 14, and the like.

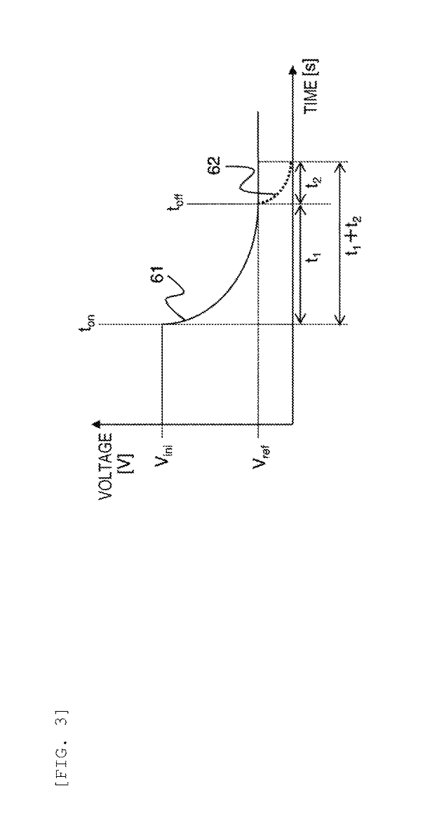

FIG. 3 is a diagram for explaining a problem of the related art in the configuration of the discharge switch 9 illustrated in FIG. 2. FIG. 3 illustrates a state of the voltage change of the load 14 and the discharge resistor 8 when the discharge switch 9 according to the related art is controlled. Specifically, FIG. 3 illustrates a state of the voltage change of the load 14 and the discharge resistor 8 when the discharge switch 9 is turned on at the time point tₒₙ to start the discharge operation of the power converter 11, the voltage of the load 14 is decreased from the pre-discharge voltage Vᵢₙᵢ toward the target voltage V_{ref}, and, then, the discharge switch 9 is turned off at the time point t_{off} when the voltage of the load 14 reaches the target voltage V_{ref}.

As illustrated in FIG. 3, during the period of time t₁ from the time tₒₙ to the time point t_{off}, the electric charges accumulated in the capacitive component 12 of the load 14 are discharged by the discharge operation of the power converter 11, and, therefore, the voltage of the load 14 is decreased as illustrated by the graph 61. After the discharge switch 9 is turned off at the time point t_{off}, a high voltage continues to be applied to the discharge resistor 8 during the turn-off time t₂ of the discharge switch 9, and, therefore, the voltage of the discharge resistor 8 is decreased as illustrated by the graph 62. Thus, the power converter 11 cannot proceed to the next voltage step-up operation until the total time t₁+t₂ of the time t₁ and the time t₂ elapses.

Therefore, in order to reduce the dead time due to the turn-off time of the discharge switch 9 as described above, the power converter 11 according to this embodiment sets a predetermined threshold voltage that is higher than the target voltage V_{ref} with respect to the output voltage Vₒᵤₜ. Then, when the output voltage Vₒᵤₜ is lower than the threshold voltage, the discharge switch 9 is controlled to turn off the discharge switch 9 and cut off the electric conduction to the discharge resistor 8. Furthermore, at this time, the aforementioned threshold voltage is corrected by considering the temperature dependency of the load 14. For this reason, as illustrated in FIG. 2, the target voltage V_{ref} and the temperature T_{load} of the load 14 are input to the discharge controller 51. The temperature T_{load} of the load 14 can be detected by, for example, a temperature sensor using a thermocouple or other means.

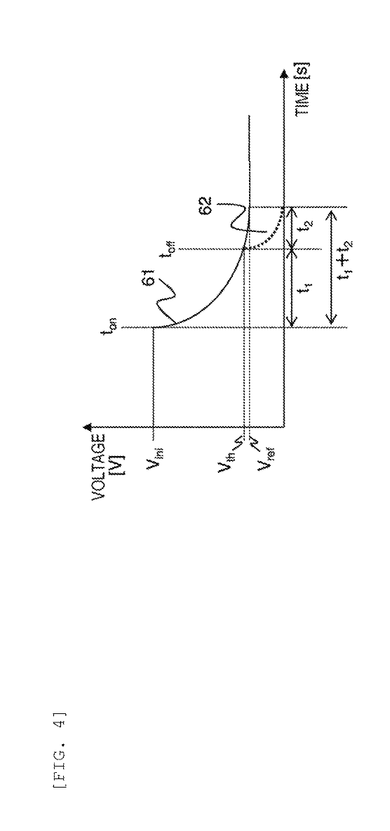

FIG. 4 is a diagram for explaining a principle of a method of controlling the discharge switch 9 by the power converter 11 according to this embodiment. FIG. 4 illustrates a state of the voltage change of the load 14 and the discharge resistor 8 when the threshold voltage Vₜₕ is set to be higher than the target voltage V_{ref} in the power converter 11 and the control of the discharge switch 9 is performed by using the threshold voltage Vₜₕ. Specifically, FIG. 4 illustrates a state of the voltage change of the load 14 and the discharge resistor 8 when the discharge switch 9 is turned on at the time point tₒₙ to start the discharge operation of the power converter 11, the voltage of the load 14 is decreased from the pre-discharge voltage Vᵢₙᵢ toward the target voltage V_{ref}, and, then, the discharge switch 9 is turned off at the time point t_{off} when the voltage of the load 14 reaches the threshold voltage Vₜₕ that is higher than the target voltage V_{ref}.

In FIG. 4, when the voltage of the load 14 reaches the threshold voltage Vₜₕ, the discharge switch 9 is turned off in expectation of the voltage drop amount of the load 14 at the subsequent turn-off time t₂ of the discharge switch 9. Therefore, since the time t₁ from the time point tₒₙ to the time point t_{off} can be shortened as compared with the control method according to the related art illustrated in FIG. 3, it is possible to reduce the dead time until the next voltage step-up operation in the power converter 11.

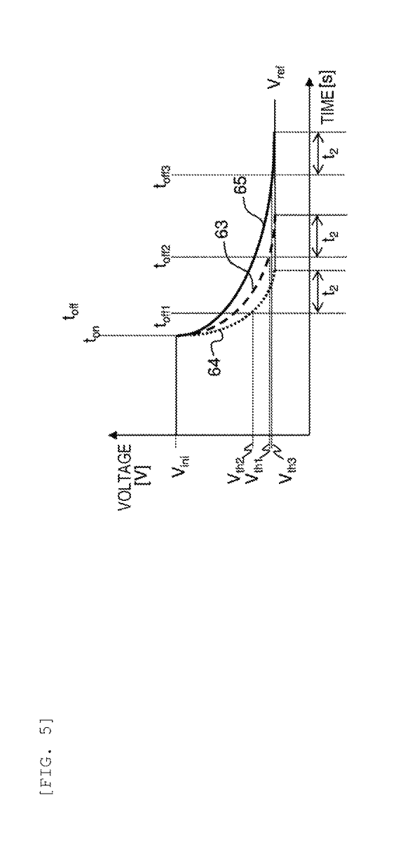

FIG. 5 is a diagram for explaining a principle of a method of correcting a threshold voltage by the power converter 11 according to this embodiment. FIG. 5 illustrates a state of change in the slope of the voltage change of the load 14 due to the discharge operation of the power converter 11 according to the temperature.

When the capacitive component 12 or the resistive component 13 of the load 14 has temperature dependency, the slope of the voltage change of the load 14 during discharge is changed in response to the temperature of the load 14, as illustrated in FIG. 5. For example, if the load 14 is an ERF, the voltage of the load 14 is decreased as illustrated by the graph 63 due to the discharge operation of the power converter 11 at a room temperature. On the other hand, since at a high temperature, the product of the capacitive component 12 and the resistive component 13 of the load 14 is changed to a value smaller than that at a room temperature, the charge time constant of the voltage dividing condensers 27 to 29 is decreased. As a result, the slope of the voltage change of the load 14 increases, and the voltage of the load 14 decreases as illustrated by the graph 64. On the other hand, since at a low temperature, the product of the capacitive component 12 and the resistive component 13 of the load 14 is changed to a value larger than that at a room temperature, the charge time constant of the voltage dividing condensers 27 to 29 is increased. As a result, the slope of the voltage change of the load 14 is decreased, and the voltage of the load 14 is decreased as illustrated by the graph 65.

Therefore, in the power converter 11 according to this embodiment, the threshold voltage at which the discharge switch 9 is turned off is changed in response to the change in the slope of the voltage change of the load 14 due to the temperature as described above. Specifically, when the temperature of the load 14 is high, the threshold voltage at which the discharge switch 9 is turned off is increased, for example, to be changed from the threshold voltage Vₜₕ 1 at a room temperature to the threshold voltage Vₜₕ 2 at a high temperature. On the other hand, when the temperature of the load 14 is low, the threshold voltage at which the discharge switch 9 is turned off is decreased, for example, to be changed from the threshold voltage Vₜₕ 1 at a room temperature to the threshold voltage Vₜₕ 3 at a low temperature. Accordingly, it is possible to appropriately correct the threshold voltage at which the discharge switch 9 is turned off by considering the temperature dependency of the load 14. As a result, in either case, it is possible to allow the turn-off time t₂ of the discharge switch 9 that occurs after turning off the discharge switch 9 to be the same degree.

The correction of the threshold voltage in response to the temperature of the load 14 as described above can be applied not only to a case where the load 14 is an ERF but also to a case where the load is another material such as a dielectric elastomer. It is conceivable that the same effect can be obtained as long as a high voltage needs to be applied and the electrostatic capacitance value or the resistance value has temperature dependency.

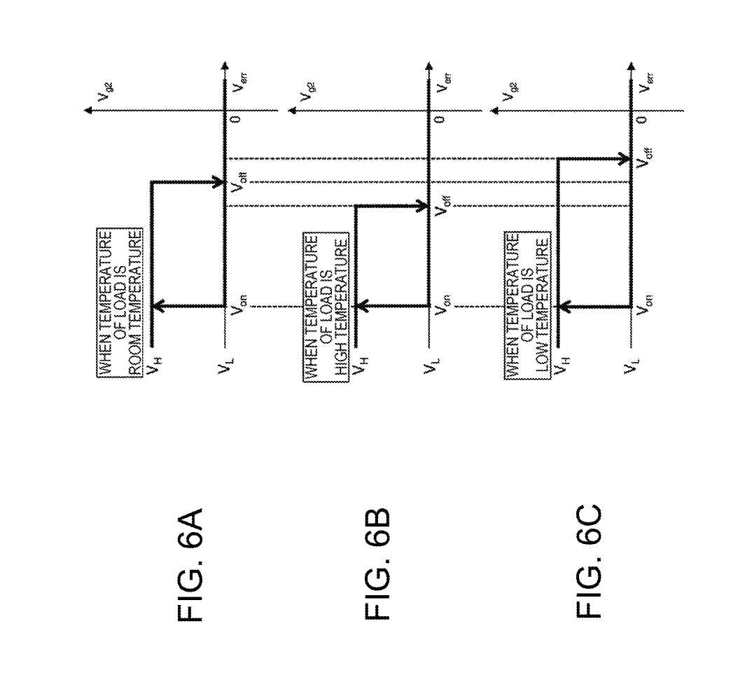

FIG. 6 is a diagram illustrating characteristics of a hysteresis comparator in the discharge controller 51. The discharge controller 51 includes a hysteresis comparator having the characteristics as illustrated in FIG. 6 in order to perform ON/OFF control of the discharge switch 9 in response to the temperature of the load 14. In FIG. 6, (a) illustrates the characteristics of the hysteresis comparator when the temperature of the load 14 is a room temperature, (b) illustrates the characteristics of the hysteresis comparator when the temperature of the load 14 is a high temperature, and (c) illustrates the characteristics of the hysteresis comparator when the temperature of the load 14 is a low temperature.

When the temperature of the load 14 is a room temperature, the discharge controller 51 outputs the control signal V_{g2} to the discharge switch driving circuit 10 in response to the characteristics of the hysteresis comparator as illustrated in FIG. 6(a). That is, when the value of the control signal V_{g2} is a low level V_{L} corresponding to the off state of the discharge switch 9, and the difference value Vₑᵣᵣ obtained by subtracting the output voltage Vₒᵤₜ from the target voltage V_{ref} is smaller than a predetermined discharge start threshold value Vₒₙ, the discharge controller 51 switches the discharge switch 9 to the on state by changing the control signal V_{g2} from the low level V_{L} to a high level V_{H}. On the other hand, when the value of the control signal V_{g2} is the high level V_{H} corresponding to the on state of the discharge switch 9, and the difference value Vₑᵣᵣ obtained by subtracting the output voltage Vₒᵤₜ from the target voltage V_{ref} is larger than a predetermined discharge end threshold value V_{off} (Vₒₙ<V_{off}), the discharge controller 51 switches the discharge switch 9 to the off state by changing the control signal V_{g2} from the high level V_{H} to the low level V_{L}.

When the temperature of the load 14 is changed from a room temperature, the discharge controller 51 changes the characteristics of the hysteresis comparator to correct the discharge end threshold value V_{off} in response to the temperature of the load 14 while the discharge start threshold value Vₒₙ is not changed but maintained to be constant. For example, if the load 14 is an ERF, and the temperature of the load 14 is changed from a room temperature to a high temperature, the discharge controller 51 changes the characteristics of the hysteresis comparator so that the discharge end threshold value V_{off} is increased to the low voltage side, that is, in the negative direction as illustrated in (b). On the other hand, if the temperature of the load 14 is changed from a room temperature to a low temperature, the discharge controller 51 changes the characteristics of the hysteresis comparator so that the discharge end threshold value V_{off} is increased to the high voltage side, that is, the positive direction as illustrated in (c).

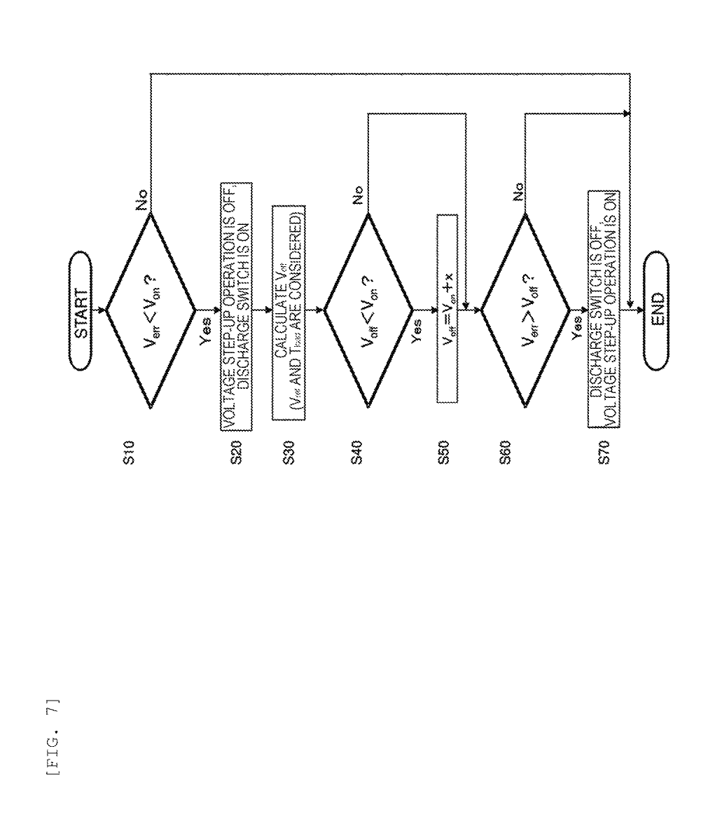

FIG. 7 is a diagram illustrating a control flow of the discharge switch 9 in the first embodiment of the present invention. The processes illustrated in this control flow are executed in the discharge controller 51 while the voltage step-up operation is performed in the power converter 11.

In step S10, the discharge controller 51 determines whether or not the difference value Vₑᵣᵣ of the output voltage Vₒᵤₜ with respect to the target voltage V_{ref} input thereto is smaller than a predetermined discharge start threshold value Vₒₙ. As a result, if the difference value Vₑᵣᵣ is smaller than the discharge start threshold value Vₒₙ, the process proceeds to step S20. If the difference value Vₑᵣᵣ is equal to or larger than the discharge start threshold value Vₒₙ, the process illustrated in the control flow of FIG. 7 ends.

In step S20, the discharge controller 51 stops the voltage step-up operation by outputting the control signal V_{g1} so that the AC switching element 4 is turned off, and starts the electric conduction to the discharge resistor 8 by outputting the control signal V_{g2} so that the discharge switch 9 is turned on. As a result, the electric charges accumulated in the capacitive component 12 of the load 14 are discharged, and thus, the voltage of the load 14 is decreased.

In step S30, the discharge controller 51 calculates a discharge end threshold value V_{off} based on the target voltage V_{ref} input thereto and the temperature T_{load} of the load 14. Herein, as described above, the value of the discharge end threshold value V_{off} is calculated so that, as the temperature T_{load} of the load 14 becomes higher, the discharge end threshold value V_{off} is increased in the negative direction and, as the temperature T_{load} of the load 14 becomes lower, the discharge end threshold value V_{off} is increased in the positive direction. For example, by using a previously stored table, function, or the like, the discharge end threshold value V_{off} in response to the temperature T_{load} of the load 14 can be calculated in this manner. Therefore, it is possible to correct the threshold voltage Vₜₕ with respect to the output voltage Vₒᵤₜ in response to the temperature T_{load} of the load 14.

In step S40, the discharge controller 51 determines whether or not the value of the discharge end threshold value V_{off} calculated in step S30 is smaller than the discharge start threshold value Vₒₙ. When the discharge end threshold value V_{off} is smaller than the discharge start threshold value Vₒₙ, the discharge controller 51 corrects the discharge end threshold value V_{off} to be larger than the discharge start threshold value Vₒₙ in step S50. Herein, for example, by setting the value that a predetermined value x is added to the discharge start threshold value Vₒₙ as a discharge end threshold value V_{off}, it is possible to correct the discharge end threshold value V_{off}. As long as the discharge end threshold value V_{off} is larger than the discharge start threshold value Vₒₙ, the correction of the discharge end threshold value V_{off} may be performed by other methods. After executing step S50, the discharge controller 51 sets the corrected discharge end threshold value V_{off}, and the process proceeds to step S60. On the other hand, when it is determined in step S40 that the discharge end threshold value V_{off} is equal to or larger than the discharge start threshold value Vₒₙ, the discharge controller 51 sets the discharge end threshold value V_{off} calculated in step S30 without executing step S50, and the process proceeds to step S60.

In step S60, the discharge controller 51 determines whether or not the difference value Vₑᵣᵣ of the output voltage Vₒᵤₜ with respect to the target voltage V_{ref} input thereto is smaller than the set discharge end threshold value V_{off}. As a result, if the difference value Vₑᵣᵣ is larger than the discharge end threshold value V_{off}, the process proceeds to step S70. If the difference value Vₑᵣᵣ is equal to or smaller than the discharge end threshold value V_{off}, the process illustrated in the control flow of FIG. 7 ends.

In step S70, the discharge controller 51 cuts off the electric conduction to the discharge resistor 8 by outputting the control signal V_{g2} so that the discharge switch 9 is turned off, and starts the voltage step-up operation by outputting the control signal V_{g1} so that the AC switching element 4 repeats on and off. After executing step S70, the discharge controller 51 ends the process illustrated in the control flow of FIG. 7.

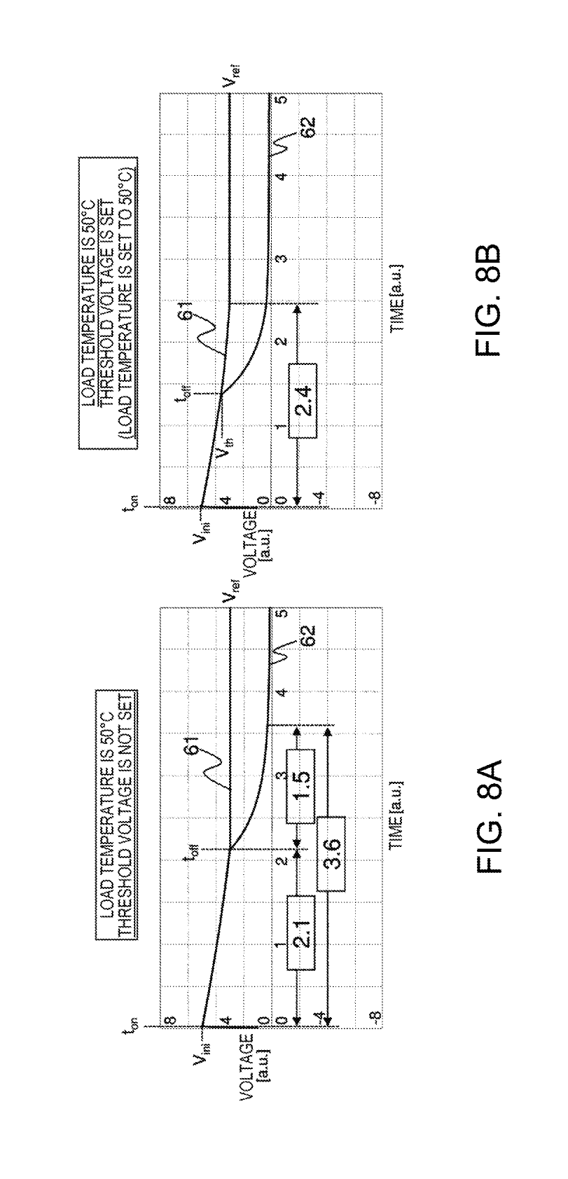

Next, the effects of the present invention will be described by using examples of the voltage changes of the load 14 and the discharge resistor 8 illustrated in FIGS. 8 to 10. In FIGS. 8 to 10, it is assumed that an ERF is used for the load 14.

FIG. 8 illustrates a state of the voltage change of the load 14 and the discharge resistor 8 when the temperature of the load 14 is a room temperature (50° C.). In FIG. 8, (a) illustrates a state of the voltage change of the load 14 and the discharge resistor 8 when the control of the discharge switch 9 is performed without setting the threshold voltage Vₜₕ described so far, as an example of the case where the control of the discharge switch 9 is performed in the related art. On the other hand, (b) illustrates a state of the voltage change of the load 14 and the discharge resistor 8 when the control of the discharge switch 9 is performed by setting the threshold voltage Vₜₕ, as an example when the control of the discharge switch 9 is performed according to the present invention. In addition, in FIG. 8, similarly to FIGS. 3 and 4, the voltage change of the load 14 is illustrated by the graph 61 and the voltage change of the discharge resistor 8 by the turn-off time of the discharge switch 9 is illustrated by the graph 62.

As illustrated in FIG. 8(a), when the threshold voltage Vₜₕ is not set, the discharge switch 9 is turned off at the time point t_{off} when the voltage of the load 14 reaches the target voltage V_{ref}. For this reason, similar to the case described with reference to FIG. 3, the dead time in response to the turn-off time of the discharge switch 9 occurs, and thus, the period of time from the time point tₒₙ when the discharge switch 9 is turned on to the time point when the turn-off of the discharge switch 9 is completed becomes 3.6 [a.u.].

On the other hand, as illustrated in FIG. 8(b), when the threshold voltage Vₜₕ is set, similarly to the case described with reference to FIG. 4, when the voltage of the load 14 reaches the threshold voltage Vₜₕ, the discharge switch 9 is turned off in expectation of the voltage drop amount of the load 14 in the turn-off time of the discharge switch 9. For this reason, at the time point when the voltage of the load 14 reaches the target voltage V_{ref}, the voltage of the discharge resistor 8 drops by 90% or more from the voltage of the load 14, and the turn-off of the discharge switch 9 can be substantially completed. As a result, the period of time from the time point tₒₙ when the discharge switch 9 is turned on to the time point when the turn-off of the discharge switch 9 is completed becomes 2.4 [a.u.]. That is, as compared with the case where the threshold voltage Vₜₕ is not set, it is possible to reduce the period of time from the time point tₒₙ when the discharge switch 9 is turned on to the time point when the turn-off of the discharge switch 9 is completed by 30% or more.

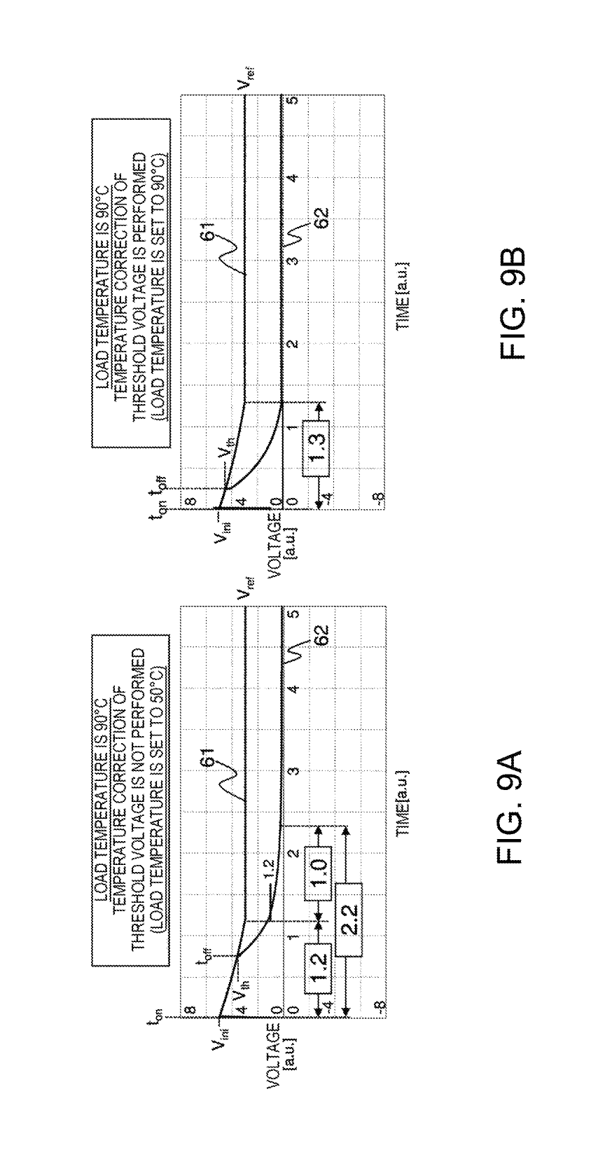

FIG. 9 illustrates a state of the voltage change of the load 14 and the discharge resistor 8 when the temperature of the load 14 is a high temperature (90° C.). In FIG. 9, (a) illustrates a state of the voltage change of the load 14 and the discharge resistor 8 when the control of the discharge switch 9 is performed by using the same threshold voltage Vₜₕ as when the temperature of the load 14 is 50° C., as an example of the case where the correction of the threshold voltage Vₜₕ at a high temperature is not performed. On the other hand, (b) illustrates a state of the voltage change of the load 14 and the discharge resistor 8 when the control of the discharge switch 9 is performed by using the threshold voltage Vₜₕ when the temperature of the load 14 is 90° C., as an example when the correction of the threshold voltage Vₜₕ at a high temperature is performed. In addition, in FIG. 9, similarly to FIGS. 3 and 4, the voltage change of the load 14 is illustrated by the graph 61, and the voltage change of the discharge resistor 8 by the turn-off time of the discharge switch 9 is illustrated by the graph 62.

As illustrated in FIG. 9(a), when the threshold voltage Vₜₕ is not corrected, the influence that the slope of the voltage change of the load 14 during discharge is increased due to the temperature increase of the load 14 is not considered. Therefore, even when the voltage of the load 14 reaches the target voltage V_{ref}, a voltage of 1.2 [a.u.] is applied to the discharge resistor 8. Therefore, until the voltage of the discharge resistor 8 drops by 90% or more from the voltage of the load 14 and the turn-off of the discharge switch 9 is substantially completed, a period of time of 1.0 [a.u.] is further taken as the dead time corresponding to the turn-off time of the discharge switch 9. As a result, the period of time from the time point tₒₙ when the discharge switch 9 is turned on to the time point when the turn-off of the discharge switch 9 is completed becomes 2.2 [a.u.].

On the other hand, as illustrated in FIG. 9(b), when the threshold voltage Vₜₕ is corrected, the influence that the slope of the voltage change of the load 14 during discharge is increased due to the temperature increase of the load 14 is considered, and the threshold voltage Vₜₕ is increased. For this reason, at the time point when the voltage of the load 14 reaches the target voltage V_{ref}, the voltage of the discharge resistor 8 drops by 90% or more from the voltage of the load 14, and the turn-off of the discharge switch 9 can be substantially completed. As a result, the period of time from the time point tₒₙ when the discharge switch 9 is turned on to the time point when the turn-off of the discharge switch 9 is completed becomes 1.3 [a.u.]. That is, as compared with the case where the threshold voltage Vₜₕ is not corrected, it is possible to reduce the period of time from the time point tₒₙ when the discharge switch 9 is turned on to the time point when the turn-off of the discharge switch 9 is completed by about 40%. Furthermore, when the threshold voltage Vₜₕ is not corrected, the discharge to the discharge resistor 8 is continued despite the voltage of the load 14 reaching the target voltage V_{ref}, and, thus, loss due to over-discharge occurs. On the other hand, when the threshold voltage Vₜₕ is corrected, the loss due to such over-discharge can also be reduced.

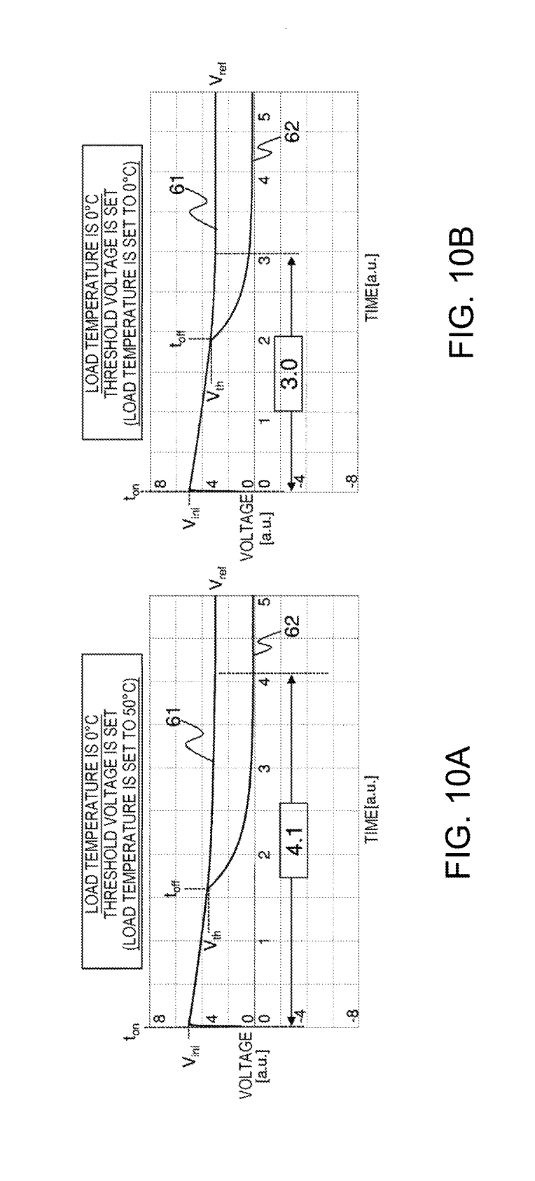

FIG. 10 illustrates a state of the voltage change of the load 14 and the discharge resistor 8 when the temperature of the load 14 is a low temperature (0° C.). In FIG. 10, (a) illustrates a state of the voltage change of the load 14 and the discharge resistor 8 when the control of the discharge switch 9 is performed by using the same threshold voltage Vₜₕ as when the temperature of the load 14 is 50° C., as an example when the correction of the threshold voltage Vₜₕ at a low temperature is not performed. On the other hand, (b) illustrates a state of the voltage change of the load 14 and the discharge resistor 8 when the control of the discharge switch 9 is performed by using the threshold voltage Vₜₕ when the temperature of the load 14 is 0° C., as an example when the correction of the threshold voltage Vₜₕ at a low temperature is performed. In FIG. 10, similarly to FIGS. 3 and 4, the voltage change of the load 14 is illustrated by the graph 61, and the voltage change of the discharge resistor 8 by the turn-off time of the discharge switch 9 is illustrated by the graph 62.

As illustrated in FIG. 10(a), when the threshold voltage Vₜₕ is not corrected, the influence that the slope of the voltage change of the load 14 during discharge is decreased due to the temperature decrease of the load 14 is not considered. Therefore, the discharge switch 9 is turned off before the voltage of the load 14 drops sufficiently, and thus, the period of time from the time point tₒₙ when the discharge switch 9 is turned on to the time point when the voltage of the load 14 reaches the target voltage V_{ref} becomes 4.1 [a.u.].

On the other hand, as illustrated in FIG. 10(b), when the threshold voltage Vₜₕ is corrected, the influence that the slope of the voltage change of the load 14 during discharge is decreased due to the temperature decrease of the load 14 is considered, and thus, the threshold voltage Vₜₕ is decreased. Therefore, the discharge switch 9 can be turned off at the time point when the voltage of the load 14 sufficiently drops. As a result, the period of time from the time point tₒₙ when the discharge switch 9 is turned on to the time point when the voltage of the load 14 reaches the target voltage V_{ref} becomes 3.0 [a.u.]. That is, in comparison with the case where the threshold voltage Vₜₕ is not corrected, the period of time from the time point tₒₙ when the discharge switch 9 is turned on to the time point when the voltage of the load 14 reaches the target voltage V_{ref} can be reduced by about 27%. Furthermore, at the time point when the voltage of the load 14 reaches the target voltage V_{ref}, the voltage of the discharge resistor 8 drops by 90% or more from the voltage of the load 14, and the turn-off of the discharge switch 9 can be substantially completed.

According to the first embodiment of the present invention described above, the following operational effects are obtained.

(1) The power converter 11 converts the DC input voltage to the DC output voltage Vₒᵤₜ and outputs the DC output voltage to the load 14. The power converter 11 includes the discharge resistor 8 for discharge the electric charges accumulated in the load 14, the discharge switch 9 for switching the electric conduction state of the discharge resistor 8, and the discharge controller 51 for controlling the discharge switch 9 so that the output voltage Vₒᵤₜ becomes a predetermined target voltage V_{ref}. When the output voltage Vₒᵤₜ is lower than a predetermined threshold voltage Vₜₕ that is larger than the target voltage V_{ref}, the discharge controller 51 controls the discharge switch 9 to cut off the electric conduction of the discharge resistor 8. Furthermore, the discharge controller 51 corrects the threshold voltage Vₜₕ in response to the temperature change of the load 14. By doing in this manner, it is possible to improve the responsiveness of the power converter 11.

(2) The discharge controller 51 corrects the threshold voltage Vₜₕ so that the threshold voltage Vₜₕ is increased when the temperature of the load 14 is increased and the threshold voltage Vₜₕ is decreased when the temperature of the load 14 is decreased. By doing in this manner, it is possible to appropriately correct the threshold voltage Vₜₕ in response to the change in the slope of the voltage change of the load 14 during discharge due to a temperature change.

Herein, the operation of the power converter 11 when an ERF is used for the load 14 will be described. As described above, since the ERF can directly control the viscosity of the fluid with an electric signal without having a moving unit, the ERF has an advantage of high responsiveness. However, in order to change the viscosity of the ERF, it is necessary to apply an electric field having a high electric field intensity of several hundreds to several thousand V/mm. Therefore, when the ERF is used for the load 14, the power converter 11 according to this embodiment needs to apply a high voltage between electrodes filled with the ERF with high responsiveness. For example, in an ERF damper for a vehicle that controls the damping force by changing the viscosity of the ERF in response to the unevenness of the road surface, high responsiveness is required for the power converter 11 that applies a high voltage to the load 14 in order to reduce the vibration in a higher frequency band. In addition, in order to control the damping force to an arbitrary value within a certain range in response to the unevenness of the road surface, it is also required that the output voltage is variable within a certain range.

The electrical equivalent circuit of the ERF can be expressed as a parallel circuit of the capacitive component 12 and the resistive component 13 as in the load 14 illustrated in FIGS. 1 and 2. For this reason, in the power converter 11, the load 14 can be considered to be a condenser load. In increasing the damping force of the ERF damper, the power converter 11 is allowed to perform a voltage step-up operation to charge the capacitive component 12 to a voltage corresponding to a desired damping force. On the other hand, in decreasing the damping force of the ERF damper, the power converter 11 is allowed to perform a discharge operation to discharge the capacitive component 12 to a voltage corresponding to a desired damping force. As a result, the damping force of the ERF damper can be controlled.

In the power converter 11 according to this embodiment, in order to improve responsiveness in decreasing the damping force of the ERF damper, the discharge resistor 8 having a resistance value smaller than the resistance value of the resistive component 13 is connected in parallel to the load 14 which is an ERF damper. However, since the power loss occurs in the discharge resistor 8 at the time other than the discharge time, which results in the efficiency reduction of the power converter 11, and thus, merely connecting the discharge resistor 8 in parallel is not preferable. Therefore, in the power converter 11, in order to improve the responsiveness when decreasing the damping force of the ERF damper and to reduce the power loss by the discharge resistor 8, the discharge switch 9 is connected in series with the discharge resistor 8. Then, the discharge switch 9 is turned on only during the discharge operation so that the capacitive component 12 of the load 14 which is the ERF damper is discharged by the discharge resistor 8.

### Second Embodiment

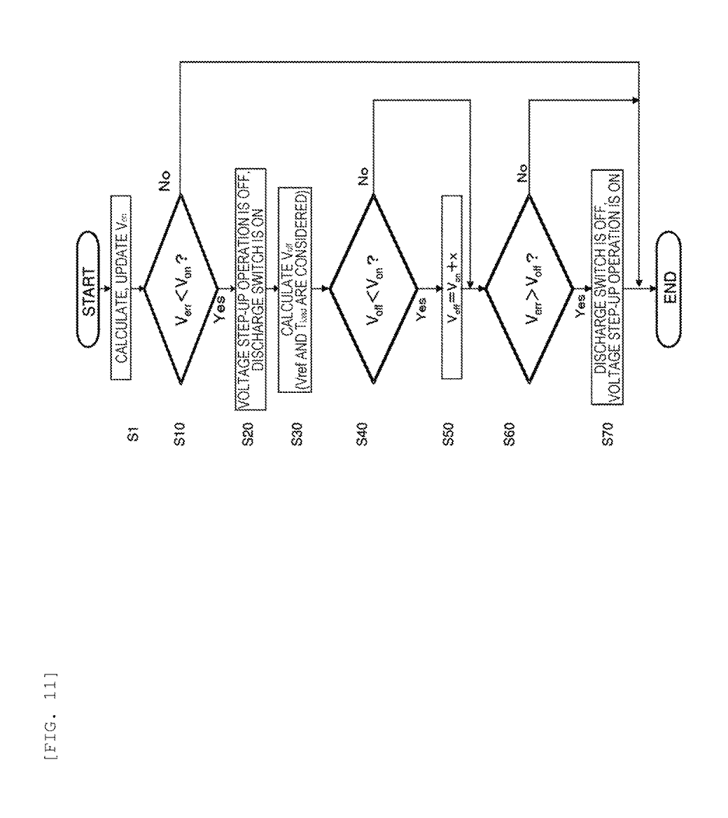

Next, a second embodiment of the present invention will be described. In the second embodiment, an embodiment of the present invention will be described with reference to FIG. 11.

In the first embodiment described above, the example where the discharge end threshold value V_{off} is corrected in response to the temperature of the load 14 while the discharge start threshold value Vₒₙ is kept constant without being changed has been described. On the other hand, in the second embodiment of the present invention, an example where the discharge start threshold value Vₒₙ is changed in response to a difference between the target voltage V_{ref} and the output voltage Vₒᵤₜ will be described.

FIG. 11 is a diagram illustrating a control flow of the discharge switch 9 according to the second embodiment of the present invention. The processes illustrated in this control flow are executed by the discharge controller 51 while the voltage step-up operation is performed in the power converter 11, similarly to the processes in the first embodiment illustrated in the control flow of FIG. 7. In FIG. 11, the processes having the same contents as those in FIG. 7 are denoted by the same step numbers.

In step S1, the discharge controller 51 calculates a discharge start threshold value Vₒₙ based on the difference value Vₑᵣᵣ of the output voltage Vₒᵤₜ with respect to the target voltage V_{ref} input thereto. Herein, the discharge start threshold value Vₒₙ is calculated so that the discharge start threshold value Vₒₙ is decreased as the value of the difference value Vₑᵣᵣ obtained by subtracting the output voltage Vₒᵤₜ from the target voltage V_{ref} is decreased, that is, as the difference between the target voltage V_{ref} and the output voltage Vₒᵤₜ is increased. When the discharge start threshold value Vₒₙ can be calculated, the discharge controller 51 updates the discharge start threshold value Vₒₙ based on the calculation result, and the process proceeds to step S10. Since the processes after step S10 is the same as those in FIG. 7, the description thereof will be omitted.

Herein, when the discharge end threshold value V_{off} is smaller than the discharge start threshold value Vₒₙ, and the difference value Vₑᵣᵣ is smaller than the discharge end threshold value V_{off} and larger than the discharge start threshold value Vₒₙ, chattering in which the discharge switch 9 is repetitively turned on and off occurs. For this reason, in the process flow of FIG. 11, by the processes of steps S40 and S50, the discharge end threshold value V_{off} is limited to be necessarily larger than the discharge start threshold value Vₒₙ so that the chattering does not occur.

According to the second embodiment of the present invention described above, when the difference value Vₑᵣᵣ obtained by subtracting the output voltage Vₒᵤₜ from the target voltage V_{ref} becomes smaller than a predetermined discharge start threshold value Vₒₙ (step S10: Yes), the discharge controller 51 controls the discharge switch 9 so that electric conduction of the discharge resistor 8 starts (step S20). In addition, the discharge controller 51 updates the discharge start threshold value Vₒₙ so that the discharge start threshold value Vₒₙ is decreased as the difference value Vₑᵣᵣ obtained by subtracting the output voltage Vₒᵤₜ from the target voltage V_{ref} is decreased (step S1). By doing in this manner, the setting range of the discharge end threshold value V_{off} can be enlarged without narrowing the operation range of the discharge switch 9, and thus, the effect of the invention can be improved. That is, in order to enlarge the setting range of the discharge end threshold value V_{off}, it is necessary to set the discharge start threshold value Vₒₙ to a large value in the negative direction. However, if this setting is always done, the operation range of the discharge switch 9 is narrowed. Therefore, by updating the discharge start threshold value Vₒₙ to an appropriate value in response to the difference between the target voltage V_{ref} and the output voltage Vₒᵤₜ as described above, the setting range of the discharge end threshold value V_{off} can be enlarged without narrowing the operation range of the discharge switch 9. As a result, it is possible to maximize the effect of the present invention as described in the first embodiment.

### Third Embodiment

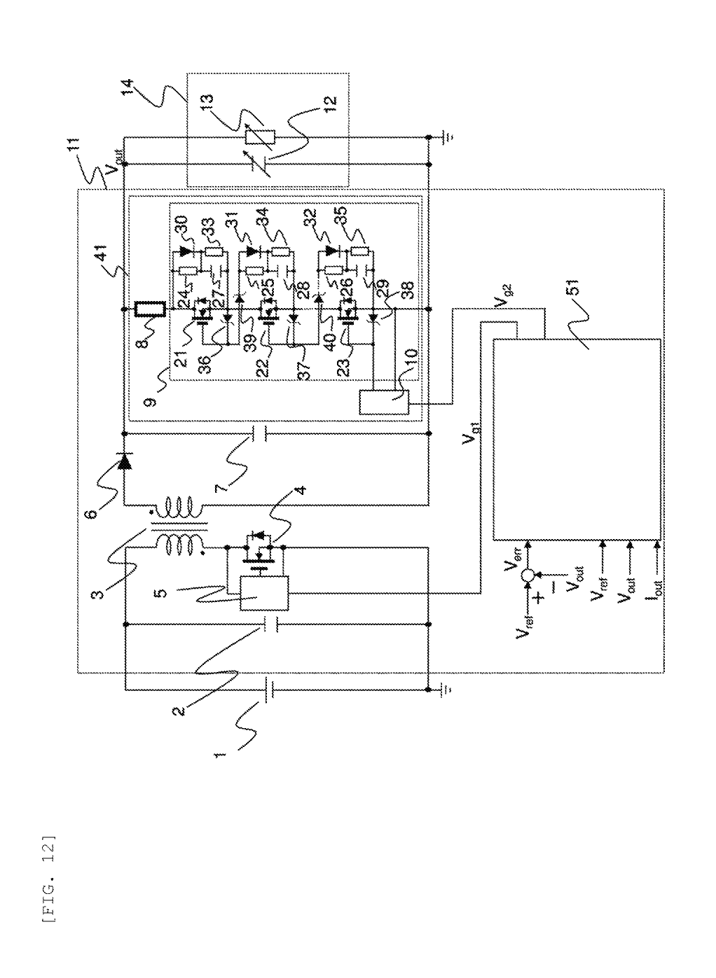

Next, a third embodiment of the present invention will be described. In the third embodiment, one embodiment of the present invention will be described with reference to FIG. 12.

In the first embodiment described above, the example where the temperature T_{load} of the load 14 is detected and the threshold voltage Vₜₕ is corrected based on the detection result has been described. On the other hand, in the third embodiment of the present invention, an example where the threshold voltage Vₜₕ is corrected based on the product of the resistance value and the electrostatic capacitance value of the load 14 will be described.

FIG. 12 is a diagram illustrating a configuration of the power converter 11 according to the third embodiment of the present invention. The power converter 11 illustrated in FIG. 12 has the same configuration as the power converter 11 according to the first embodiment illustrated in FIG. 2 except for a portion of the information input to the discharge controller 51. That is, in the first embodiment, the temperature T_{load} of the load 14 is input to the discharge controller 51. However, in this embodiment, instead of the temperature T_{load}, the output voltage Vₒᵤₜ and the output current Iₒᵤₜ of the power converter 11 are input to the discharge controller 51.

In this embodiment, the discharge controller 51 calculates the value of the discharge end threshold value V_{off} by using the output voltage Vₒᵤₜ and the output current Iₒᵤₜ input thereto. Specifically, the electrostatic capacitance value of the capacitive component 12 and the resistance value of the resistive component 13 in the load 14 are obtained based on the output voltage Vₒᵤₜ and the output current Iₒᵤₜ, and the product thereof is calculated. Then, the value of the discharge end threshold value V_{off} is calculated based on the calculated product and the target voltage V_{ref} so that the discharge end threshold value V_{off} is increased in the negative direction as the product is decreased and the discharge end threshold value V_{off} is increased in the positive direction as the product is increased. For example, the discharge end threshold value V_{off} in response to the product of the electrostatic capacitance value and the resistance value of the load 14 can be calculated by using a previously stored table, function, or the like. As a result, when the product of the electrostatic capacitance value of the capacitive component 12 and the resistance value of the resistive component 13 is decreased due to the temperature increase of the load 14 and, thus, the slope of the voltage change of the load 14 during discharge increase, the threshold voltage Vₜₕ can be allowed to increase by considering the influence thereof. On the other hand, when the product of the electrostatic capacitance value of the capacitive component 12 and the resistance value of the resistive component 13 is increased due to the temperature decrease of the load 14 and, thus, the slope of the voltage change of the load 14 during discharge is decreased, the threshold voltage Vₜₕ can be allowed to be decreased by considering the influence thereof. Therefore, similarly to the first embodiment, even when the capacitive component 12 or the resistive component 13 of the load 14 has temperature dependency, it is possible to appropriately correct the threshold voltage for turning off the discharge switch 9. Furthermore, it is also possible to cope with secular change of the load 14.

If the secular change of the electrostatic capacitance value of the capacitive component 12 or the resistance value of the resistive component 13 in the load 14 is small, it is possible to estimate the temperature T_{load} of the load 14 based on at least one of the electrostatic capacitance value and the resistance value obtained from the output voltage Vₒᵤₜ and the output current Iₒᵤₜ, and the previously acquired temperature characteristics. By using the temperature T_{load} of the load 14 estimated in this manner, it is possible to perform the same control as that in the first embodiment even if there is no temperature detection means such as a temperature sensor.

Herein, the discharge controller 51 can calculate the resistance value of the resistive component 13 in the load 14 from the ratio between the output voltage Vₒᵤₜ of the power converter 11 and the output current Iₒᵤₜ flowing from the power converter 11 to the load 14. Alternatively, the resistance value of the resistive component 13 in the load 14 may also be calculated from the conductivity or the resistivity of the load 14, and the length and cross-sectional area of the current path in the load 14.

Furthermore, the discharge controller 51 can calculate the electrostatic capacitance value of the capacitive component 12 in the load 14 from the ratio between the charge time constant or the discharge time constant of the load 14, and the resistance value of the resistive component 13 in the load 14. Alternatively, when the load 14 has a pair of electrodes facing each other at both ends, the electrostatic capacitance value of the capacitive component 12 in the load 14 can also be calculated from a dielectric constant or a relative dielectric constant of the load 14 and the distance between the electrodes and the facing area of the pair of electrodes.

Furthermore, the discharge controller 51 may obtain the output voltage Vₒᵤₜ or the output current Iₒᵤₜ of the power converter 11 by calculation. For example, when the load 14 has a pair of electrodes facing each other at both ends as described above, the output voltage Vₒᵤₜ can be calculated from the distance between the electrodes and the electric field intensity at the pair of electrodes. Furthermore, the output current Iₒᵤₜ can be calculated from the current density and the cross-sectional area in the current path in the load 14.

According to the third embodiment of the present invention described above, the discharge controller 51 corrects the threshold voltage Vₜₕ in response to the change in the product of the electrostatic capacitance value and the resistance value of the load 14. That is, the threshold voltage Vₜₕ is corrected so that, the threshold voltage Vₜₕ is increased when the product of the electrostatic capacitance value and the resistance value of the load 14 is decreased, and the threshold voltage Vₜₕ is decreased when the product of the electrostatic capacitance value of the load 14 and the resistance value is increased. By doing in this manner, it is possible to appropriately correct the threshold voltage Vₜₕ in response to the change in the slope of the voltage change of the load 14 during discharge due to a temperature change or a secular change. Therefore, similarly to the first embodiment, it is possible to improve the responsiveness of the power converter 11.

In addition, the above-described embodiments are merely examples, and the present invention is not limited to these contents as long as the features of the invention are not impaired. In addition, although various embodiments have been described above, the present invention is not limited to these contents. Other modes conceivable within the technical idea of the present invention are also included within the scope of the present invention.

The disclosure content of the following priority application is incorporated herein by reference.

Japanese Patent Application No. 2016 156624 (filed on Aug. 9, 2016)

### REFERENCE SIGNS LIST

1: DC power supply
2: input-side smoothing condenser
3: step-up transformer
4: AC switching element
5: AC switching element driving circuit
6: rectifier diode
7: output-side smoothing condenser
8: discharge resistor
9: discharge switch
10: discharge switch driving circuit
11: power converter
12: capacitive component
13: resistive component
14: load
51: discharge controller

1. A power converter for converting a DC input voltage to a DC output voltage and outputting the DC output voltage to a load, the power converter comprising:
a discharge resistor for discharging electric charges accumulated in the load, a discharge switch for switching an electric conduction state of the discharge resistor; and
a discharge controller for controlling the discharge switch so that the output voltage becomes a predetermined target voltage, wherein
the discharge controller controls the discharge switch to cut off electric conduction of the discharge resistor when the output voltage is lower than a predetermined threshold voltage that is higher than the target voltage, and
the discharge controller corrects the threshold voltage in response to a temperature change of the load.

2. The power converter according to claim 1, wherein
the discharge controller corrects the threshold voltage so that the threshold voltage is increased when the temperature of the load is increased, and the threshold voltage is decreased when the temperature of the load is decreased.

3. The power converter according to claim 1, wherein
the discharge controller estimates the temperature of the load based on at least one of an electrostatic capacitance value and a resistance value of the load.

4. A power converter for converting a DC input voltage to a DC output voltage and outputting the DC output voltage to a load, the power converter comprising:
a discharge resistor for discharging electric charges accumulated in the load;
a discharge switch for switching an electric conduction state of the discharge resistor; and
a discharge controller for controlling the discharge switch so that the output voltage becomes a predetermined target voltage, wherein
the discharge controller controls the discharge switch to cut off the electric conduction of the discharge resistor when the output voltage is lower than a predetermined threshold voltage that is higher than the target voltage, and
the discharge controller corrects the threshold voltage in response to a change in a product of an electrostatic capacitance value and a resistance value of the load.

5. The power converter according to claim 4, wherein
the discharge controller corrects the threshold voltage so that the threshold voltage is increased when a product of the electrostatic capacitance value and the resistance value of the load is decreased, and the threshold voltage is decreased when the product of the electrostatic capacitance value and the resistance value of the load is increased.

6. The power converter according to claim 3, wherein
the discharge controller obtains the resistance value of the load from a ratio between the output voltage and an output current flowing through the load.

7. The power converter according to claim 3, wherein
the discharge controller obtains the resistance value of the load based on the conductivity or the resistivity of the load and a length and a cross-sectional area of a current path in the load.

8. The power converter according to claim 3, wherein
the discharge controller obtains the electrostatic capacitance value of the load from a ratio between a charge time constant or a discharge time constant of the load and the resistance value of the load.

9. The power converter according to claim 3, wherein
the load has a pair of electrodes facing each other at both ends, and
the discharge controller obtains the electrostatic capacitance value of the load based on a dielectric constant or a relative dielectric constant of the load and a distance between the electrodes in the pair of electrodes and a facing area thereof.

10. The power converter according to claim 1, wherein
the load has a pair of electrodes facing each other at both ends, and
the discharge controller obtains the output voltage based on a distance between electrodes and an electric field intensity in the pair of electrodes.

11. The power converter according to claim 6, wherein
the discharge controller obtains the output current based on a current density and a cross-sectional area in a current path of the load.

12. The power converter according to claim 1, wherein
the load is an electrorheological fluid.

13. The power converter according to claim 1, wherein
the load is a dielectric elastomer.

14. The power converter according to claim 1, wherein
the discharge switch is configured to connect a plurality of semiconductor switches in series,
each of the plurality of semiconductor switches includes a collector terminal or a drain terminal, and an emitter terminal or a source terminal, and
a condenser is connected separately between the collector terminal and the emitter terminal or between the drain terminal and the source terminal of each semiconductor switch.

15. The power converter according to claim 1, wherein
the discharge switch is configured to connect a plurality of semiconductor switches in series,
each of the plurality of semiconductor switches includes a gate terminal, and an emitter terminal or a source terminal, and
a condenser is connected separately between the emitter terminal or the source terminal of the semiconductor switch on a low voltage side, and the gate terminal of the semiconductor switch on a high voltage side in a pair of adjacent semiconductor switches.

16. The power converter according to claim 1, wherein
the discharge controller controls the discharge switch to start electric conduction of the discharge resistor when a value obtained by subtracting the output voltage from the target voltage is smaller than a predetermined discharge start threshold value, and
the discharge controller updates the discharge start threshold value.

17. The power converter according to claim 16, wherein
the discharge controller updates the discharge start threshold so that the discharge start threshold is decreased as the value obtained by subtracting the output voltage from the target voltage is decreased.
